(19) United States
(12) Patent Application Publication
(10) Pub. No.: US 2009/0328169 A1
(43) Pub. Date: Dec. 31, 2009

(54) Apparatus and method for convenient and secure access to websites

(76) Inventors: Keith Hutchison, Phoenix, AZ (US); Lonny Hutchison, Bonnie Lake, WA (US)

Correspondence Address: WRIGHT LAW GROUP, PLLC, 7201 WEST OAKLAND, SUITE 2, CHANDLER, AZ, 85226, US

(21) Appl. No.: 11/339,353

(22) Filed: Jan. 25, 2006

(51) Int. Cl. H04L 9/32; G06F 21/00; G06F 17/30

(52) U.S. Cl. 726/7; 707/104.1; 707/E17.044; 707/10

(57) ABSTRACT

A website access application accesses an encrypted central repository on a user's computer to store and access a variety of user-based website login and authentication information in the repository. The central repository provides a single point of access for the authentication information and, by accessing the repository; the process of user identification and authentication for multiple websites can be automated. A single user-selected keystroke combination can be utilized to initiate user sessions with multiple disparate secure websites by accessing the user website login information contained in the central repository and extracting the user login and authentication information contained therein. Additionally, the website access application will track and report on the times savings associated with the streamlined login process for accessing secure websites. In yet another preferred embodiment of the present invention, the website access application will analyze the user authentication information for various websites and provide suggestions to enhance the relative strength of the authentication information. Finally, the website access application supports a wide variety of user authentication protocols, thereby ensuring secure access to the repository.

### BACKGROUND OF THE INVENTION

1. Field of the Invention

The present invention relates generally to the field of Internet security and more specifically relates to the use of passwords and identification codes for accessing secure websites on the Internet.

2. Background Art

The use of the Internet to initiate and complete a wide variety of transactions is increasing at an exponential rate. Many transactions that were formerly conducted via paper-based forms and inter-personal communications are now routinely performed at various websites on the Internet. When Internet-based transaction systems were initially introduced, many users were concerned about providing sensitive information for fear of having the information intercepted by unauthorized parties. Accordingly, many users avoided Internet-based transactions. This fear, as well as many highly publicized incidents of actual theft of sensitive information, has led to the widespread deployment of “secure websites.”

Secure websites are, in the broadest sense, websites that employ some combination of data encryption, secure communication, user identification and authentication, etc. The use of encryption protocols, dedicated channels, and communication standards such as “secure sockets layer” or SSL are all forms of security measures that have been adopted to enhance the security of Internet-based transactions. Additionally, security for a given website may be embodied by the use of various identification authentication protocols (passwords, IP address verification, etc.). Password authentication is among the most well-known and widely implemented type of authentication found on the Internet today. In the case of passwords, a “strong” password is characterized by a relatively longer length and more complex content. For example, a combination of letters and numbers, including upper and lower case letters, is “stronger” than a relatively “weak” password that is shorter in length and comprises some user-related content (i.e., name, birthdate, etc.) In order to enhance security, a website operator may insist on the use of a “strong” password for user authentication. The use of these various authentication protocols and security methods are well known to those skilled in the art.

While there is no doubt that the adoption of various security measures and identification protocols has significantly improved the security of internet-based transactions, this enhanced security has not been implemented without cost. For example, many individuals are frequent shoppers at various Internet shopping sites and routinely purchase items from a broad spectrum of Internet-based vendors. However, these vendors have generally deployed mutually exclusive security measures, such as user authentication, for their respective websites. Some websites require an email address and password for user identification and authentication. Other websites may require a user name and password. In addition, most websites have adopted various patterns for valid passwords. For example, some websites require the use of a combination of both letters and numbers for a password. Other websites may dictate a minimum and/or maximum length of acceptable password. Some websites will require that the user change their password every so often, all in order to enhance security and prevent fraudulent transactions.

These often conflicting protocols and standards have resulted in a situation where seasoned Internet users are now regularly identified by a baffling and rapidly growing combination of mutually exclusive passwords, ID codes, email addresses, user names, etc. While not a huge problem for some users, the wide variety of different standards and different protocols required for accessing most websites can be very unwieldy and will introduce an element of friction and frustration for many regular users. The proliferation of websites displaying and implementing password and username recovery options is indicative of the problem now plaguing many users. While small snippets of code known as “cookies” may be stored on the user's computer, these cookies can be prone to security compromises and may provide inadvertent access to unauthorized users.

Additionally, the problems associated with present methods of user identification and authentication may also be personified by the user who has forgotten his or her password for a given website and has engaged in the process of trying any one of their laundry list of passwords in a frequently vain attempt to gain access to the desired website. In other cases, the problem may be manifest by a user selecting relatively “weak” passwords in an attempt to simplify their future attempts to access a given website. While this may provide the user with a lower level of stress, it may also make it easier for an unauthorized person to compromise and improperly access the user's account. In extreme cases, the user will simply give up and abandon their efforts to conduct various transactions on the Internet. This is obviously counter-productive for the user as well as for the company, vendor, or agency that operates the website.

While the various presently known implementations of Internet security methods for user identification and authentication are not without merit, most existing methods of simplifying the identification authentication process have one or more significant drawbacks, such as reduced security, weak authentication standards, or the like. In these situations, and using the currently available technology, additional opportunities for streamlining the user identification and authentication process will be similarly limited and lack significant potential for growth and industry adoption. Accordingly, without developing improved methods of user identification and authentication, the use of the Internet to conduct transactions of all kinds will continue to be sub-optimal.

### SUMMARY OF THE INVENTION

A website access application accesses an encrypted central repository on a user's computer to store and access a variety of user-based website login and authentication information in the repository. The central repository provides a single point of access for the authentication information and, by accessing the repository; the process of user identification and authentication for multiple websites can be automated. A single user-selected keystroke combination can be utilized to initiate user sessions with multiple disparate secure websites by accessing the user website login information contained in the central repository and extracting the user login and authentication information contained therein. Additionally, the website access application will track and report on the times savings associated with the streamlined login process for accessing secure websites. In yet another preferred embodiment of the present invention, the website access application will analyze the user authentication information for various websites and provide suggestions to enhance the relative strength of the authentication information. Finally, the website access application supports a wide variety of user authentication protocols, thereby ensuring secure access to the repository.

### BRIEF DESCRIPTION OF THE DRAWINGS

The preferred embodiments of the present invention will hereinafter be described in conjunction with the appended wherein like designations denote like elements and:

FIG. 1 is a block diagram of a computer system for providing convenient and secure access to websites in accordance with a preferred embodiment of the present invention;

FIG. 2 is a block diagram of a client computer for providing convenient and secure access to websites in accordance with a preferred embodiment of the present invention;

FIG. 3 is a flowchart of a method for providing convenient and secure access to websites in accordance with a preferred embodiment of the present invention;

FIG. 4 is a flowchart of a method for automatically accessing secure websites in accordance with a preferred embodiment of the present invention;

FIG. 5 is a representative user interface for accessing a website and entering user authentication data and website data into a website database in accordance with an exemplary preferred embodiment of the present invention;

FIG. 6 is a representative user interface for verifying user authentication data and website data for entry into a website database in accordance with an exemplary preferred embodiment of the present invention;

FIG. 7 is a representative user interface for displaying user authentication data and website data stored in a website database in accordance with an exemplary preferred embodiment of the present invention;

FIG. 8 is a representative user interface for reporting cumulative time savings for automated user authentication in accordance with an exemplary preferred embodiment of the present invention;

FIG. 9 is a representative user interface for setting user preferences for a user authentication mechanism in accordance with an exemplary preferred embodiment of the present invention;

FIG. 10 is a representative user interface for displaying user login ID and password data in accordance with an exemplary preferred embodiment of the present invention; and

FIG. 11 is a representative user interface for implementing user validation in accordance with an exemplary preferred embodiment of the present invention.

### DETAILED DESCRIPTION

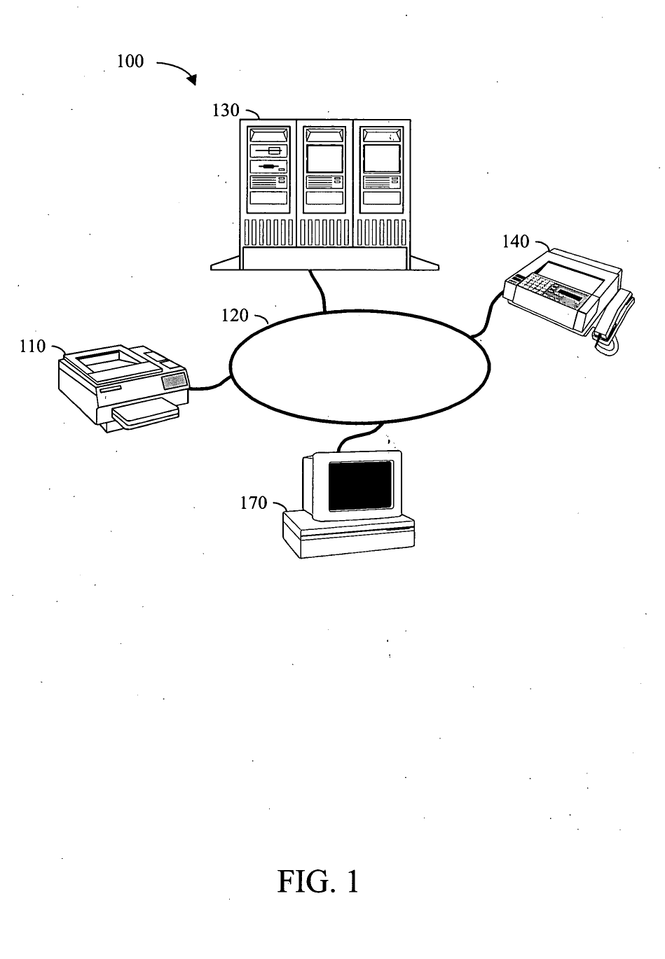

Referring now to FIG. 1, a block diagram of a computer-based system 100 for providing convenient and secure access to websites in accordance with a preferred embodiment of the present invention comprises: a data server 130 and a computer 170 connected or coupled via a network 120. Additionally, an optional printer 110 and an optional fax machine 140 are shown. Taken together, the components of computer-based system 100 provide a way for users to quickly and easily access secure websites as described herein in conjunction with the various preferred embodiments of the present invention.

Data server 130 represents a relatively powerful computer system that is made available to computer 170 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database-servers, web servers, firewalls, security software, and the like. The use of these various hardware and software components is well known to those skilled in the art.

Given the relative advances in the state-of-the-art computer systems available today, it is anticipated that functions of data server 130 may be provided by many standard, readily available data servers. Depending on the desired size and relative power required for data server 130, storage area network (SAN) technology may also be deployed in certain preferred embodiments of the present invention. Additionally, various biometric and identification verification devices for creating and verifying digital signatures (i.e., electronic signature processing) may also be included. In general, data server 130 will be used as a web server to provide access to one or more websites via a web browser using the Internet.

Computer 170 may be any type of computer system known to those skilled in the art that is capable of being configured for use with computer-based system 100 as described herein. This includes laptop computers, desktop computers, tablet computers, pen-based computers and the like. Additionally, handheld and palmtop devices are also specifically included within the description of devices that may be deployed as a computer 170. It should be noted that no specific operating system or hardware platform is excluded and it is anticipated that many different hardware and software platforms may be configured to create computer 170. As previously explained in conjunction with data server 130, various hardware components and software components (not shown this FIG.) known to those skilled in the art may be used in conjunction with computer 170. It should be noted that in the most preferred embodiments of the present invention, computer 170 is linked to its own LAN or WAN and has access to its own data server (not shown this FIG.). It should also be noted that the use of computer standards such as JAVA, XML and XSL allows the methods of the present invention to be platform independent.

Network 120 is any suitable computer communication link or communication mechanism, including a hardwired connection, an internal or external bus, a connection for telephone access via a modem, DSL, or high-speed T1 line, radio, infrared or other wireless communication methodologies, private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission line, Digital Subscriber Line (DSL), ISDN line, or similar public utility-like access link.

In the most preferred embodiments of the present invention; network 120 represents and comprises a standard Internet connection between the various components of computer-based system 100. Network 120 provides for communication between the various components of computer-based system 100 and allows for relevant information to be transmitted from device to device. In this fashion, a user of computer-based system 100 can quickly and easily gain access to the relevant data and information utilized to procure and deploy mortgage loans via the implementation of universal document libraries as described in conjunction with the preferred embodiments of the present invention. Regardless of physical nature and topology, network 120 serves to logically link the physical components of computer-based system 100 together, regardless of their physical proximity. This is especially important because in many preferred embodiments of the present invention, data server 130 and computer 170 will be geographically remote and separated from each other.

In general, data server 130 processes requests for various transactions received from computer 170. A typical transaction may be represented by a request to access a website hosted by data server 130. In this case, a request to access a given website is sent from computer 170 to data server 130. Data server 130 processes the request and takes the specific action requested by computer 170 relative to the requested website. The request may be directed towards accessing a secure website, in which case the use of a website access application in accordance with a preferred embodiment of the present invention will be indicated. Finally, while depicted as a single computer, in certain preferred embodiments of the present invention data server 130 may be implemented as a cluster of multiple data servers, with separate and possibly redundant hardware and software systems. This configuration provides additional robustness for system uptime and reliability purposes.

It should be noted that while FIG. 1 shows only a single computer 170, it is anticipated that the most preferred embodiments of the present invention will comprise thousands and even hundreds of thousands of computers 170. Each of these computers 170 will be configured to access data server 130 in an appropriately secure way so as to accomplish the specific objectives of the user of the computer 170. In the most preferred embodiments of the present invention, multiple computers 170 will be configured to communicate with data server 130 and with each other via network 120.

Optional printer 110 and an optional fax machine 140 are standard peripheral devices that may be used for transmitting or outputting paper-based documents, notes, transaction records, reports, etc. in conjunction with the transactions processed by computer-based system 100. Optional printer 110 and an optional fax machine 140 may be directly connected to network 120 or indirectly connected to network 120 via any or all of computer 170 and/or data server 130. Finally, it should be noted that optional printer 110 and optional fax machine 140 are merely representative of the many types of peripherals that may be utilized in conjunction with computer-based system 100. It is anticipated that other similar peripheral devices will be deployed in the various preferred embodiment of the present invention and no such device is excluded by its omission in FIG. 1.

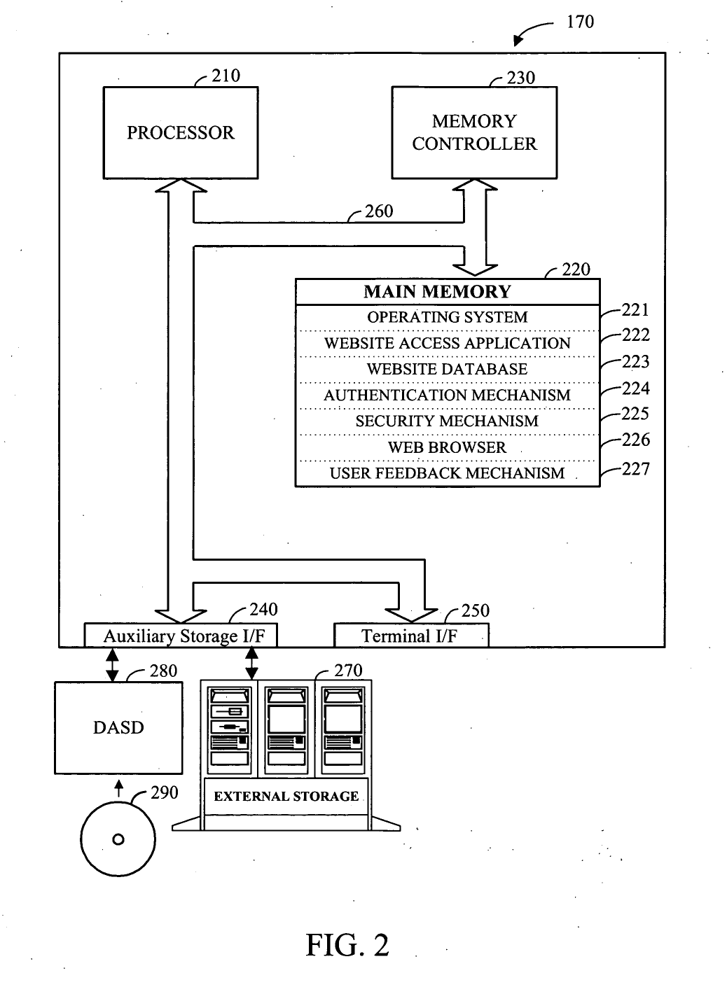

Referring now to FIG. 2, a computer 170 in accordance with a preferred embodiment of the present invention is a commercially available computer system such as a Linux-based computer system, IBM compatible computer system, or Macintosh computer system. However, those skilled in the art will appreciate that the methods and apparatus of the present invention apply equally to any computer system, regardless of whether the computer system is a traditional “mainframe” computer, a complicated multi-user computing apparatus or a single user device such as a personal computer or workstation.

Computer 170 suitably comprises at least one Central Processing Unit (CPU) or processor 210, a main memory 220, a memory controller 230, an auxiliary storage interface 240, and a terminal interface 250, all of which are interconnected via a system bus 260. Note that various modifications, additions, or deletions may be made to computer 170 illustrated in FIG. 2 within the scope of the present invention such as the addition of cache memory or other peripheral devices. FIG. 2 is not intended to be exhaustive, but is presented to simply illustrate some of the salient features of computer 170.

Processor 210 performs computation and control functions of computer 170, and comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor. Processor 210 suitably executes one or more software programs contained within main memory 220.

Auxiliary storage interface 240 allows computer 170 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a CD or DVD disk drive that may read programs and data from a disk 290. It is important to note that while the present invention has been (and will continue to be) described in the context of a fully functional computer system, those skilled in the art will appreciate that the various software applications and mechanisms of the present invention are capable of being distributed in conjunction with signal bearing media as one or more program products in a variety of forms, and that the various preferred embodiments of the present invention applies equally regardless of the particular type or location of signal bearing media used to actually carry out the distribution. Examples of signal bearing media include: recordable type media such as floppy disks (e.g., disk 290) and CD ROMS, and transmission type media such as digital and analog communication links, including wireless communication links.

Memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the function provided by memory controller 230 may actually reside in the circuitry associated with processor 210, main memory 220, and/or auxiliary storage interface 240.

Terminal interface 250 allows users, system administrators and computer programmers to communicate with computer 170, normally through separate workstations or through stand-alone computer systems such as data server 130 of FIG. 1. Although computer 170 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bidirectional communication in a computer-related environment could be used.

Main memory 220 suitably contains an operating system 221, a website access application 222, a website database 223, an authentication mechanism 224, a security mechanism 225, a web browser 226, and a user feedback mechanism 227. The term “memory” as used herein refers to any storage location in the virtual memory space of data server 130.

It should be understood that main memory 220 may not necessarily contain all parts of all components shown. For example, portions of operating system 221 may be loaded into an instruction cache (not shown) for processor 210 to execute, while other files may well be stored on magnetic or optical disk storage devices (not shown). In addition, although website database 223 is shown to reside in the same memory location as operating system 221, it is to be understood that main memory 220 may consist of multiple disparate memory locations. It should also be noted that any and all of the individual components shown in main memory 220 might be combined in various forms and distributed as a stand-alone program product. Finally, it should be noted that additional components, not shown in this figure, might also be included.

Operating system 221 includes the software that is used to operate and control computer 170. In general, processor 210 typically executes operating system 221. Operating system 221 may be a single program or, alternatively, a collection of multiple programs that act in concert to perform the functions of an operating system. Any operating system (Windows® Linux® and/or Mac OSX®) now known to those skilled in the art or later developed may be considered for inclusion with the various preferred embodiments of the present invention.

Website access application 222 is a computer software application adapted for use in conjunction with the preferred embodiments of the present invention. Web access application 222 is specifically designed to gather information relative to user identification and authentication for multiple secure Internet websites. Working in conjunction with web browser 226 and website database 223, website access application 222 may be configured to help the user more quickly and easily access the user's desired websites.

Website database 223 is representative of any suitable database known to those skilled in the art. In the most preferred embodiments of the present invention, website database 223 is a Structured Query Language (SQL) compatible database file capable of storing information relative to the various websites that may be accessed in conjunction with system 100 of FIG. 1. While website database 223 is shown to be residing in main memory 220, it should be noted that website database 223 may also be physically stored in a location other than main memory 220. For example, website database 223 may be stored on external storage device 270 or DASD 280 and coupled to computer 170 via auxiliary storage I/F 240.

Authentication mechanism 224 is a software application that works in conjunction with website access application 222 to authenticate the identity of the user attempting to access the data contained in website database 223 via website access application 222. Given the relatively sensitive nature of the user identification and authentication data stored in website database 223, it is considered important to prevent unauthorized access to website database 223. Possible authentication methodologies deployed by authentication mechanism 224 include biometrics, voice authentication, DNA authentication, etc. Additional information regarding the nature-of authentication mechanism 224 and the types of user authentication performed by authentication mechanism 224 is presented below.

Security mechanism 225 is provided to enable various encryption and security features for website access application 223 and website database 224. Although shown as a separate mechanism, those skilled in the art will recognize that security mechanism 225 may be incorporated into operating system 221 and/or website access application 222. Additionally, security mechanism 225 may also provide encryption capabilities for various communications conducted via computer-based system 100, thereby enhancing the robustness of computer-based system 100. Once again, depending on the type and quantity of information stored in website database 223, security mechanism 225 may provide different levels of security and/or encryption for computer 170. Additionally, the level and type of security measures applied by security mechanism 225 may be determined by the identity and or responsibilities of the end-user and/or the nature of a given request and/or response. In some preferred embodiments of the present invention, security mechanism 225 may be contained in or implemented in conjunction with certain hardware components (not shown this FIG.) such as hardware-based firewalls, switches, dongles, and the like.

Additionally, security mechanism 225 may be configured to “wipe” or remove cookies from computer system 170 of FIG. 1 upon completion of an Internet web browsing session. With this security feature activated, security mechanism 225 is configured to remove any user identification and authentication (other than that contained in website database 223) from computer 170, thereby minimizing the opportunity for an unauthorized user to gain access to computer 170 by extracting the user identification and authentication from any cookies that may have been deposited by the user's interaction with one or more websites.

Web browser 226 may be any web browser application currently known or later developed for communicating with web servers over a network such as the Internet. Examples of suitable web browsers 226 include Safari®, Internet Explorer®, Firefox®, Netscape® and the like. Additionally, other vendors have developed or will develop web browsers that will be suitable for use with the various preferred embodiments of the present invention. Regardless of the specific form of implementation, web browser 226 provides access, including a user interface, to allow individuals and entities to interact with data server 130, including via network 120 of FIG. 1. Samples of the type of user interface presented via web browser 226 are presented below.

User feedback mechanism 227 provides additional functionality for the manufacturer and/or distributor of website access application 222. Should the user of computer 170 of FIG. 1 decide at any time that they would like to remove website access application from computer 170, website access application 222 will detect the removal sequence and remove the components as requested by the user of computer 170. Additionally, upon removal of the various components of website access application 222, website access application 222 will be configured to launch web browser 226 and navigate to the website of the manufacturer and/or the distributor of website access application 222. The user of computer 170 will then be provided with the opportunity to provide feedback regarding website access application 222, including the various reasons why the user has decided to uninstall website access application 222. This information will be aggregated, stored and provided to the manufacturer and/or the distributor of website access application 222, thereby allowing them to improve or upgrade their product, if desired.

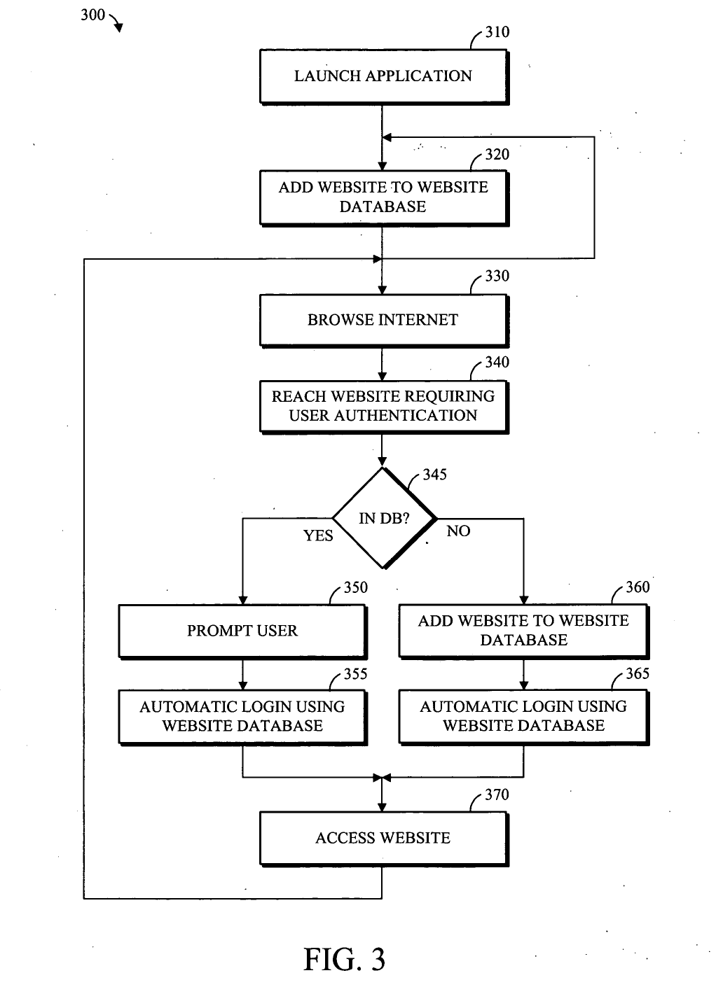

Referring now to FIG. 3, a flowchart for a method 300 for providing convenient and secure access to websites in accordance with a preferred embodiment of the present invention is depicted. As shown in FIG. 3, a user will begin by launching the website access application (step 310). At this point, the user may choose to enter user login and authentication for one or more websites (step 320). After entering user login and authentication, the user may begin to browse the Internet (step 330). At some point during the web browsing session, the user will encounter a website that requires user authentication (step 340). At this point, the website access application will access the website database to determine whether or not the user login and/or authentication information for the current website has been stored in the website database (step 345).

If the user login and/or authentication information for the current website has been stored in the website database (step 345=YES), then the website access application will prompt the user to determine whether or not the user wishes to have the website access application enter the user login and/or authentication information for the current website from the website database (step 350). If so, the website access application will provide the necessary user login and/or authentication information for the current website from the website database (step 355) and then the user will access the website (step 370).

However, if the user login and/or authentication information for the current website has not been stored in the website database (step 345=NO), then the website access application will prompt the user to determine whether or not the user wishes to have the user login and/or authentication information for the current website into the website database (step 360). If so, the website access application will gather the necessary user login and/or authentication information for the current website and store it into the website database, provide the user login and/or authentication information to the website (step 365) and then the user will access the website (step 370). This process may be repeated for the duration of the web browser session by returning to step 330 or step 320 as shown in FIG. 3.

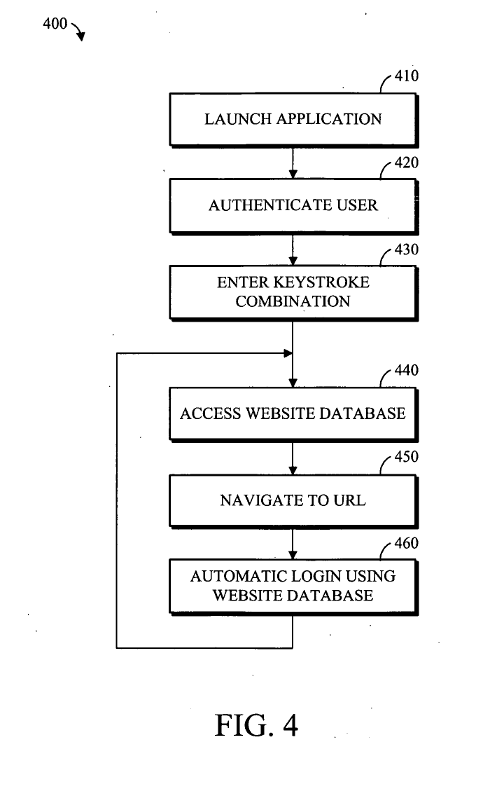

Referring now to FIG. 4, a method 400 for automatically accessing secure websites in accordance with a preferred embodiment of the present invention is depicted. The user will begin by launching the website access application (step 410). Next, in the most preferred embodiments of the present invention, the website access application will be used to authenticate the user (step 420). It is important to note that the user authentication process may be accomplished by any one of several different methodologies. In the most preferred embodiments of the present invention, a combination of various authentication methodologies will be employed.

Once the user has been authenticated, the website access application program will accept a keystroke combination entered by the user (step 430). This keystroke combination will activate a predetermined list of websites to be automatically logged in by the website access application. Accordingly, the website access application will access the previously identified portion of the website database (step 440) to identify the first URL associated with the entered keystroke. Once identified, the website access application will work in conjunction with the user's web browser software to navigate to the designated URL (step 450). Once at the designated website URL, the website access application will extract the user authentication data associated with that URL and enter the required authentication data to automatically log into the website at the designated URL (step 460). As shown in FIG. 4, this process may be repeated for as many websites are as associated with the keystroke entered by the user in step 430. In this fashion, a user may enter a single keystroke combination and have the website access application automatically login into-multiple secure websites with no further user interaction, thereby creating an “auto-login” feature for the user's pre-determined list of favorite websites.

In the most preferred embodiments of the present invention, this auto-login functionality for multiple websites can be coordinated with the built-in security system of the computer operating system. By selecting this feature, whenever the user activates the screen-locking feature of the host computer (e.g., by pressing the F2 key on the keyboard), not only will the operating system functionality of locking the computer screen to prevent unauthorized access be performed, website access application 222 of FIG. 2 will begin processing the list of websites contained in website database 223 and logging the user into the previously designated websites, with no further user interaction. Then, when the user provides the appropriate access information to the operating system to gain access to computer again, website access application will have already provided access to the desired websites. This functionality will be most useful when the computer is first powered on, in the morning or otherwise, as it will allow the user to accomplish other tasks while website access application 222 completes the process of logging the user into the various pre-designated websites.

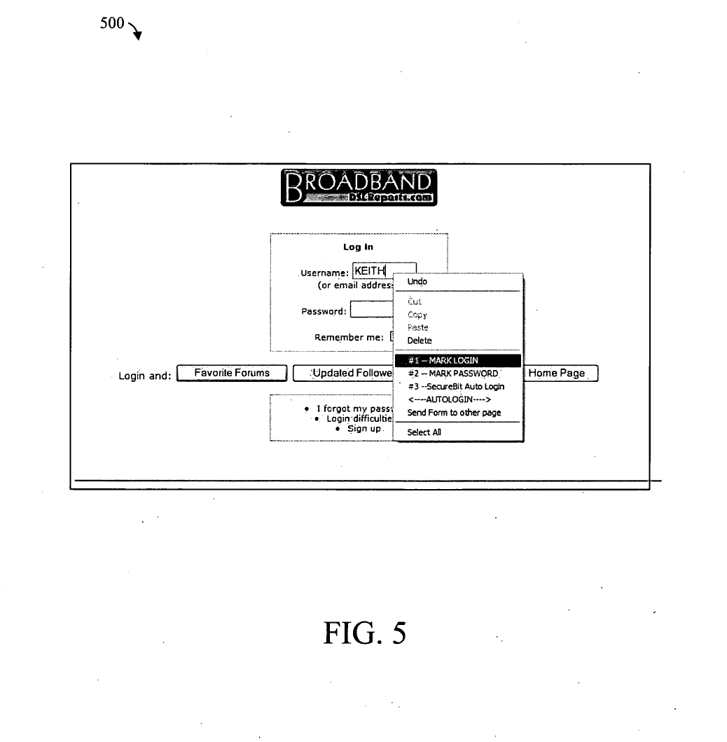

Referring now to FIG. 5, a representative user interface 500 for accessing a website and entering user authentication data and website data into a website database in accordance with an exemplary preferred embodiment of the present invention is depicted. As shown in FIG. 5, the user can navigate to the website and, while entering the user identification and authentication information for the website, also capture the user identification and authentication information for the website and store it in a website database, thereby enabling automatic secure login at a different time. After completing the website login procedure for each website accessed in this fashion, the user will be allowed an opportunity to add, delete, or otherwise edit the information stored for each website entered into the website database.

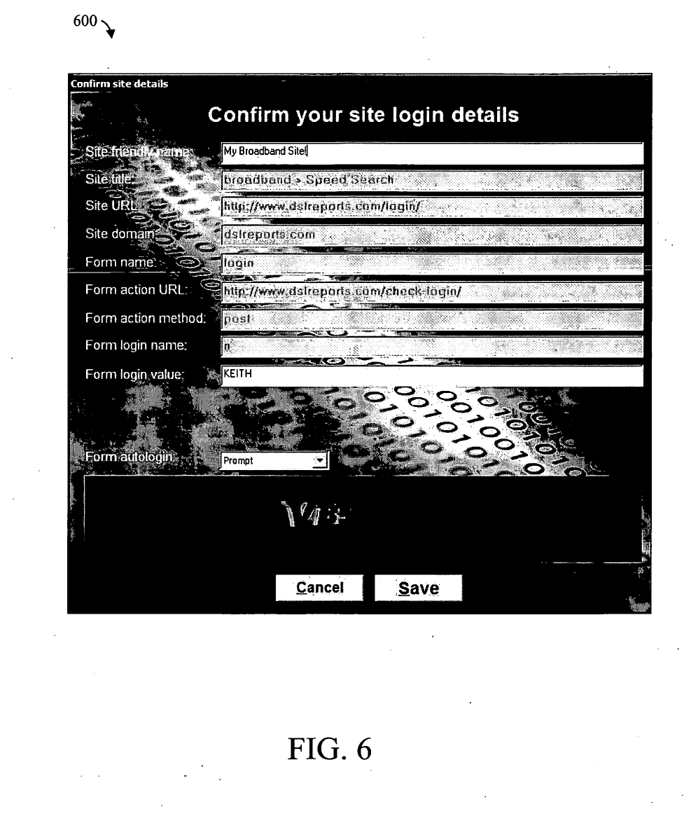

Referring now to FIG. 6, a representative user interface 600 for verifying user authentication data and website data for entry into a website database in accordance with a preferred exemplary embodiment of the present invention is depicted. As shown in FIG. 6, once the user identification and authentication information for the website has been entered into the website database, the user can access the website database via the website access application and verify that the user identification and authentication information for the website has been entered correctly. Additionally, the user can access user interface 600 to edit or modify the data contained in the website database and to also add additional information relative to accessing any given website in the future.

In yet another preferred embodiment of the present invention, the website access application can automatically monitor and capture the user's keystrokes as the user enters the user identification and authentication information at a website. These keystrokes can then be used to populate the corresponding information in the website database, thereby obviating the necessity of the user entering this information by hand. Additionally, the website access application can parse the URL for the website, extract that name of the website and use this data to populate the website database for the description of the website. In this fashion, a user may quickly and easily populate the website database. In either case, the user can always opt to return to the database and manually edit the information for any website.

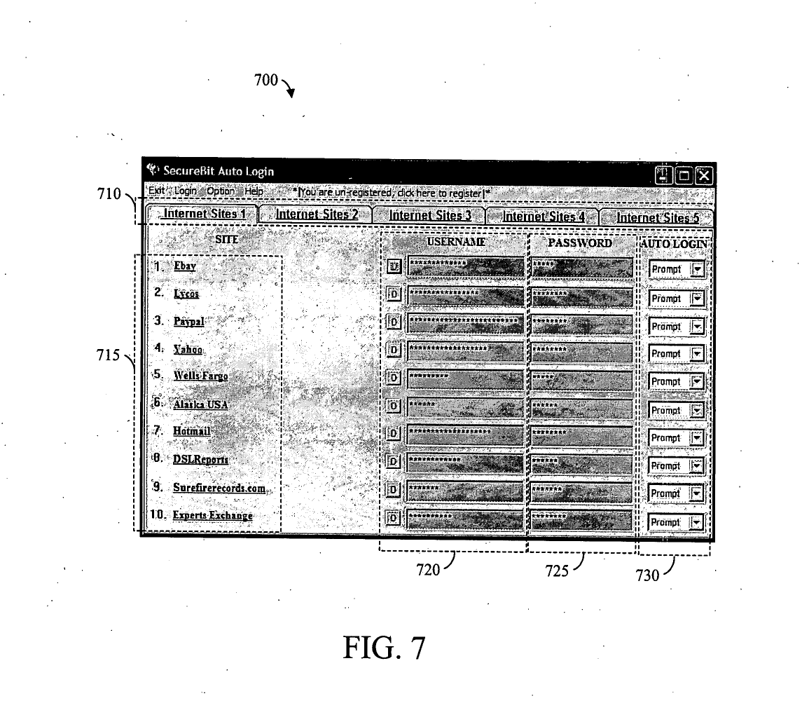

Referring now to FIG. 7, a representative user interface 700 for storing user authentication data and website data in a website database in accordance with an exemplary preferred embodiment of the present invention is depicted. User interface 700 is generated by website access application 222, operating in conjunction with web browser 226. As shown in FIG. 7, a series of tabs 710 display one or more websites 715. Information for each website 715, including the URL and the associated user identification and authentication (i.e., user names 720 and passwords 725) required to access each website 715 is stored in website database and accessed via website access application 222 working in conjunction with web browser 226. The user can group commonly accessed websites on a single tab, thereby allowing for automatic login to all websites listed on a single tabbed page. This will be particularly helpful for grouping websites with related functionality together (i.e., investment websites, entertainment websites, news websites, etc.)

Additionally, automation indicators 730 provide the user with the option of how website access application 222 should interact with secure websites when encountered. For example, the user may select fully “automatic” indicator, thereby authorizing website access application 222 to provide the necessary user identification and authentication information from website database 223 whenever necessary. Alternatively, the user could select the “prompt” indicator, thereby instructing website access application 222 to ask the user for permission-prior to accessing website database 223 to provide user identification and authentication information from website database 223. The user can also choose to selectively and temporarily deactivate one or more websites in a given group. Those skilled in the art will recognize the user interface 700 is only one possible implementation for accomplishing the purposes of the present invention and that other, similarly effective user interfaces may be implemented without departing from the spirit and scope of the present invention.

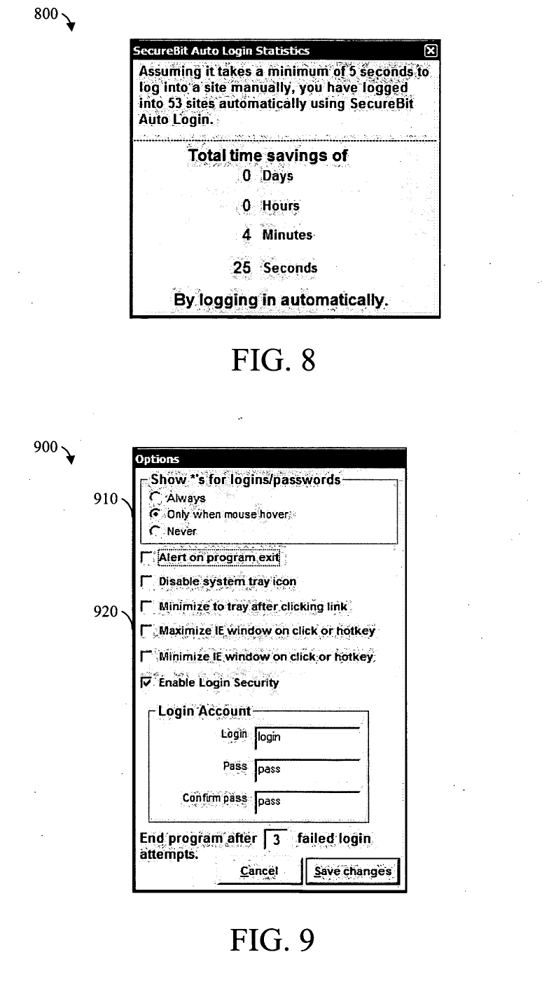

Referring now to FIG. 8, a representative user interface 800 for reporting cumulative time savings for automated user authentication in accordance with an exemplary preferred embodiment of the present invention is depicted. The various preferred embodiments of the present invention may include an algorithm that monitors the actual time spent manually logging into one or more websites versus the time required for multiple automatic login activities for multiple websites. Over a period of time, certain extrapolations can be made, deriving an approximation of the amount of time saved by using the website access application to automatically log in to different websites.

Referring now to FIG. 9, a representative user interface 900 for setting user preferences for a user authentication mechanism in accordance with an exemplary preferred embodiment of the present invention is depicted. As shown in FIG. 9, the user can interactively identify and select which security preferences they wish to employ by interacting with security preferences pane 900. Alternatively, depending on the application environment, these security features may be reserved for use by a system administrator, thereby enforcing a common level of security implementation for all users. With the option of selecting various security levels and/or features, it is possible to customize the security level and features as appropriate or necessary for a given application environment. For example, with the center radio button selected in the login/password area 910 of security preferences pane 900, the user can select whether or not and under what circumstances to view the “clear text” version of their login and/or password information. Similarly, the user can elect to control the display and performance characteristics of their browser as well by selecting the desired options in the display and performance area 920 of security preferences pane 900. An additional option in display and performance area 920 of security preferences pane 900 allows the user to minimize or maximize the web browser window with a hotkey or click. Finally, as shown in FIG. 9, the user may determine whether or not to employ security and password options for initially accessing the software.

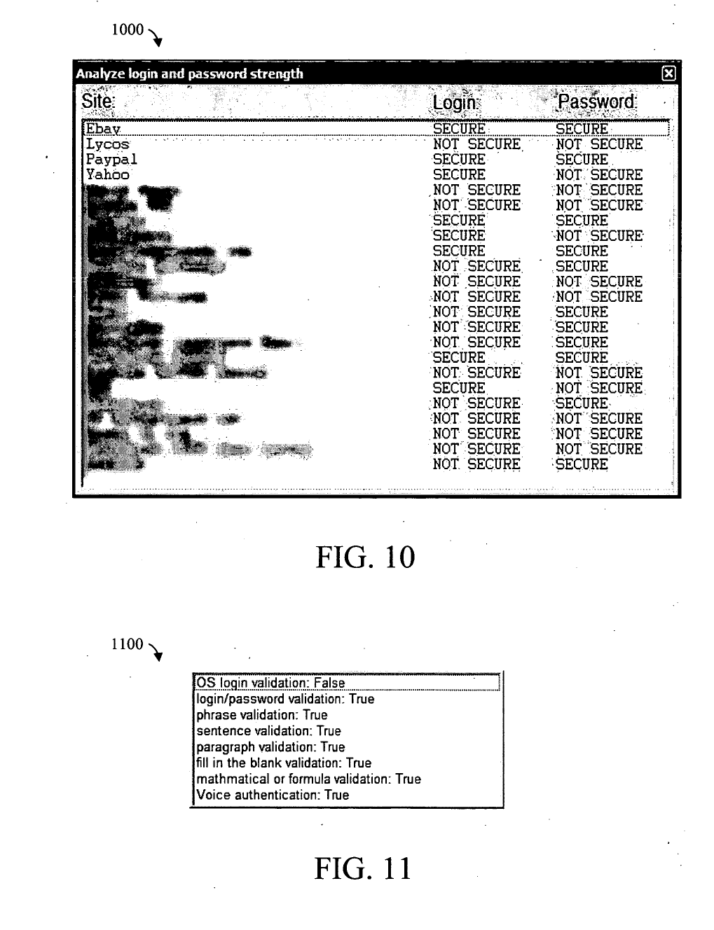

Referring now to FIG. 10, a user interface 1000 for displaying user login ID and password data is displayed. In addition to allowing a user to configure their security and other user preferences as set forth in FIG. 9, the most preferred embodiments of the website access application may also be configured to evaluate the combination of user identification. and authentication information (login ID or login name, coupled with the password) stored for each website in the website database. By using various algorithms (such as dictionary look-up, length of word, content parsing, etc.) the website access application will be able to provide a relative score for each combination of the various elements employed by a given website and make specific recommendations for increasing the relative strength of the information (i.e., make password longer, include numbers and/or symbols, use a foreign word, use a non-dictionary word, etc.). By establishing a minimum acceptable threshold score for the login information, any score that doesn't meet the threshold can be used to invalidate attempts to access one or more websites. If the login information meets the threshold, then the combination is deemed “secure” and if the login information does not meet the threshold, then the combination is deemed “not secure” and access to the website associated with that combination will be denied. In this fashion, each user will be able to adopt an appropriate level of security for those websites that they access by using the threshold evaluation provided by the application. In other preferred embodiments of the present invention, a system administrator may choose to enforce a minimum level of “strength” for user passwords, thereby denying access to any website that is associated with a “weak” login ID and/or “weak” user password. The threshold is adjustable by the user or system administrator and can be adjusted for the desired level of security.

As previously mentioned, the present invention embraces a multi-level user authentication protocol or methodology for verifying the user's identity to prevent unauthorized access to the website access application. Given the relatively sensitive nature of the login information and passwords controlled by the website access application, unauthorized access is highly undesirable. Accordingly, various security protocols or methodologies may be adopted. The partial list presented below includes a non-exclusive view of several exemplary types of protocols or methodologies that may be included in various preferred embodiments of the present invention.

Operating System (OS) based authentication (with OS login/password of x or y). This approach requires validation of the user by using the user account information associated with access to the operating system to validate the user's credentials. Similarly, a check against a centralized user account management system (e.g., Microsoft® Active Directory domain controller).

Typed login and passwords. This approach requires that the user utilize a login ID and password not associated with any OS.

Typed phrases. This approach requires that the user type in a pre-determined phrase that may be user-selected.

Typed sentences. This approach requires that the user type in a pre-determined sentence that may be user-selected.

Typed paragraphs. This approach requires that the user type in a pre-determined paragraph that may be user-selected.

Fill in the blank questionnaires. This approach requires that the user answer the questions or fill in the blanks on a questionnaire that may be user-selectable.

Mathematical problems or formulas. This approach requires that the user solve or provide the answer for a predetermined mathematical formula.

Biometric voice authentication. This approach requires that the user speak a word or phrase into a microphone and the resulting digitized voiceprint is compared against a database of voice records.

Biometric fingerprint authentication. This approach requires that the user place one or more fingers on a pressure sensitive pad that can create a digital image of the user's fingerprint. This digital image is then compared against a database of fingerprint records.

Biometric retinal scan authentication. This approach requires that the user look into a device that can create a digital image of the user's retina. This digital image is then compared against a database of retinal records.

Biometric facial authentication. This approach requires the creation of a digital image of the user's face. This digital image is then compared against a database of facial records.

DNA authentication. This approach requires that the user provide a piece of hair or other DNA containing item for authentication against a DNA database of users.

Mouse gestures or movement. This approach requires that the user perform a pre-determined mouse movement or combination of mouse movements and/or mouse clicks.

Date/time based authentication. This approach requires that the user login within a certain timeframe and/or on a certain date.

Hardware authentication. This approach requires that the user insert an external hardware device or “dongle” into a port on the computer that is being used to access the website access application.

Certificate based authentication. This approach requires that the user provide a digital certificate (e.g., SSL certificate, certificate of trust, etc.).

Signature based authentication. This approach requires that the user sign their signature using a stylus that digitizes the signature and compares the user signature against the entries in a database of known signatures.

Card based authentication. This approach requires that the user insert a card into a card reader device (e.g., smart card, credit card, etc.).

Drawing based authentication. This approach requires that the user select a pre-determined graphic from a palette of choices.

Color based authentication. This approach requires that the user select a pre-determined color or pattern from a palette of choices.

Radio Frequency Identification (RFID) based authentication. This approach requires that the user be within a certain range of a given RFID transmitter.

Sound based authentication. This approach requires that the user provide a predetermined sound (e.g., knock on their desk to produce a certain number of pounding sounds.

Picture based authentication. This approach requires that the user input a predetermined picture into a scanning device.

Security token authentication. This approach requires that a pre-determined security token be generated and passed to or intercepted by the website access application.

Global Positioning Satellite (GPS) authentication. This approach will restrict the usage of computer system 170 of FIG. 1 to a certain geographic location. In this embodiment, a GPS transponder will be included in computer system 170. Upon the launch of website access application 222 of FIG. 2, the GPS coordinates of computer system 170 will be verified by accessing the GPS coordinates via satellite communication. If computer system 170 has been moved outside of the pre-designated location, then website access application 222 will not be activated. Instead, the GPS coordinates of computer system 222 will be transmitted to a secure website and reported to the registered owner of computer system 222 and/or the law enforcement authorities.

Those skilled in the art will notice that these various protocols and methodologies may be employed in a virtually unlimited combination to achieve the desired level of security for a given situation and application. Additionally, these specific methods are not exclusive of other user identification and/or authentication protocols that may be deployed. The important point is that user access to the website access application can be protected by adopting a multi-level approach to user identification and authentication.

Referring now to FIG. 11, a user interface 1100 for performing user validation ion accordance with the preferred embodiments of the present invention is depicted. Depending on the specific validation actions desired in a given application, various options may be selected and deployed via user interface 1100 to ensure that only authorized users are allowed to access the website access application.

In summary, the present invention provides an opportunity to gather all user identification and authentication required for secure website access in a central repository, where it can be encrypted and secured from unauthorized access. Then, with a single keystroke, mouse click, or other action, a virtually unlimited number of websites can be accessed using the relevant information from the database and without requiring the user to remember or search for any additional information. Once logged in to a given website, the user can then conduct whatever business the site offers with utter and complete transparency to the website access application.

The security of the login data stored in the website access application is protected by the high grade security and encryption technology. Integrated statistics allow for the tracking of websites usage and offer the ability to look at total time saved based on average login time for a wide variety of websites. The ability for the website access application to securely analyze the relative strength of logins and passwords is available based on multiple levels of criteria (numbers, letters, both (alphanumeric), symbols or other abstract information). This analysis information can be utilized to upgrade the login and password strength to keep unauthorized persons from breaking relatively insecure logins/passwords. The ability to hide/cloak the existence of the website access application on the client machine is also important to keep login information on a compromised machine secure, even after the machine is compromised. The website access application utilizes multiple authentication layers to ensure that only the owner of the user identification and authentication information is allowed to access the website database. For example, if a virus, detection program is resident on computer system 170 of FIG. 1, the presence of a virus on computer system 170 may be used to “flag” or alert website access application 222 of FIG. 2, thereby temporarily disabling website access application 222. This will prevent unauthorized access to computer system 170 in those cases where an unauthorized user has compromised computer system 170 via a virus, worm, or the like.

Lastly, it should be appreciated that the illustrated embodiments are preferred exemplary embodiments only, and are not intended to limit the scope, applicability, or configuration of the present invention in any way. Rather, the foregoing detailed description provides those skilled in the art with a convenient road map for implementing a preferred exemplary embodiment of the present invention. Accordingly, it should be understood that various changes may be made in the function and arrangement of elements described in the exemplary preferred embodiments without departing from the spirit and scope of the present invention as set forth in the appended claims.

1. An apparatus comprising:
a processor;
a memory coupled to said processor;
a website database residing in said memory; and
a website access application residing in said memory, said website access application accessing said website database and extracting user identification and user authentication information for a user from said website database and said website database application using said user identification and said user authentication to log said user into a website.

2. The apparatus of claim 1 further comprising a security mechanism, said security mechanism being configured to evaluate the adequacy of said user identification and user authentication information and blocking access to said website if said user identification and user authentication information is deemed not secure.

3. The apparatus of claim 1 wherein said website database comprises a plurality of website records, each of said plurality of records comprising a website URL and at least a user login ID and a user password for a user of a website identified by said website URL.

4. The apparatus of claim 1 further comprising a security mechanism, said security mechanism providing encryption functionality for said website access application.

5. The apparatus of claim 1 further comprising an authentication mechanism, said authentication mechanism authenticating said user prior to allowing said user to access said website access application, said authentication mechanism authenticating said user by at least one of OS authentication, typed authentication, mathematical authentication, voice authentication, fingerprint authentication, retinal scan authentication, facial authentication, DNA authentication, mouse authentication, date/time authentication, hardware authentication, certificate authentication, signature authentication, card authentication, drawing authentication, color authentication, RFID authentication, sound authentication, picture authentication, security token authentication, and GPS authentication.

6. The apparatus of claim 1 wherein said website database comprises a plurality of website records, each of said plurality of records comprising a website URL and at least a user login ID and a user password for a user of a website identified by said website URL.

7. The apparatus of claim 1 wherein said website access application further comprises a user interface, said user interface being configured to allow said user to access said website database and create or update a plurality of website records, each of said plurality of website records comprising a website URL and at least a user login ID and a user password for a user of a website identified by said website URL.

8. The apparatus of claim 1 further comprising a security mechanism, said security mechanism being configured to remove cookies from said memory at the end of an Internet browsing session.

9. The apparatus of claim 1 further comprising:
a security mechanism, said security mechanism, said security mechanism being configured to evaluate the adequacy of said user identification and user authentication information and blocking access to said website if said user identification and user authentication information is deemed not secure;
an authentication mechanism, said authentication mechanism authenticating said user prior to allowing said user to access said website access application, said authentication mechanism authenticating said user by at least one of OS authentication, typed authentication, mathematical authentication, voice authentication, fingerprint authentication, retinal scan authentication, facial authentication, DNA authentication, mouse authentication, date/time authentication, hardware authentication, certificate authentication, signature authentication, card authentication, drawing authentication, color authentication, RFID authentication, sound authentication, picture authentication, security token authentication, GPS authentication; and
a user interface, said user interface being configured to allow said user to access said website database and create or update a plurality of website records, each of said plurality of website records comprising a website URL and at least a user login ID and a user password for said user of a website identified by said website URL.

10. The apparatus of claim 1 further comprising a user feedback mechanism residing in said memory, said user feedback mechanism being configured to navigate to a website and collect user feedback regarding said website access application upon un-installation of said website access application.

11. A method comprising the steps of:
a) navigating to a website;
b) using a website access application to access a website database to extract user identification and authentication data required for gaining access to said website; and
c) logging a user into said website using said user identification and authentication data.

12. The method of claim 11 further comprising the steps of:
capturing said user identification and authentication data for said website; and
storing said user identification and authentication data in said website database for later access to said website.

13. The method of claim 11 further comprising the step of evaluating the adequacy of said user identification and user authentication information and blocking access to said website if said user identification and user authentication information is deemed not secure.

14. The method of claim 11 further comprising the step of authenticating said user via an authentication mechanism prior to accessing said website database to verify the identity of said user.

15. The method of claim 14 where said step of authenticating said user via an authentication mechanism comprises the step of authenticating said user via at least one of OS authentication, typed authentication, mathematical authentication, voice authentication, fingerprint authentication, retinal scan authentication, facial authentication, DNA authentication, mouse authentication, date/time authentication, hardware authentication, certificate authentication, signature authentication, card authentication, drawing authentication, color authentication, RFID authentication, sound authentication, picture authentication, security token authentication, and GPS authentication.

16. The method of claim 11 further comprising the steps of:
navigating to a pre-designated website upon un-installation of said website access application; and
collecting user feedback regarding said website access application.

17. The method of claim 11 further comprising the step of repeating steps a, b, and c for a plurality of websites.

18. The method of claim 17 wherein said step of repeating steps a, b, and c for a plurality of websites is performed in conjunction with an operating system command.

19. A program product comprising:
a website database;
a website access application, said website access application; and
signal bearing media bearing said website access application.

20. The program product of claim 19 wherein said signal bearing media comprises recordable media.

21. The program product of claim 19 wherein said signal bearing media comprises transmission media.

22. The program product of claim 19 further comprising a security mechanism, said security mechanism being configured to provide security and

23. The program product of claim 19 wherein said website access application further comprises a user interface, said user interface being configured to provide an interface to said website access a

24. The program product of claim 19 further comprising an authentication mechanism, said authentication mechanism being configured to authenticate a user via at least one of OS authentication, typed authentication, mathematical authentication, voice authentication, fingerprint authentication, retinal scan authentication, facial authentication, DNA authentication, mouse authentication, date/time authentication, hardware authentication, certificate authentication, signature authentication, card authentication, drawing authentication, color authentication, RFID authentication, sound authentication, picture authentication, security token authentication, and GPS authentication.

25. The program product of claim 19 further comprising a user feedback mechanism, said user feedback mechanism being configured to navigate to a website and collect user feedback regarding said website access application.

26. The program product of claim 19 wherein said website access application is configured to repeatedly log a user into a plurality of websites in conjunction with an operating system command.
